(19) United States
(12) Patent Application Publication
(10) Pub. No.: US 2014/0078247 A1
(43) Pub. Date: Mar. 20, 2014

(54) IMAGE ADJUSTER AND IMAGE ADJUSTING METHOD AND PROGRAM

(71) Applicants: Makoto SHOHARA, Hachioji-shi (JP); Toru Harada, Kawasaki-shi (JP); Hirokazu Takenaka, Kawasaki-shi (JP); Yoichi Ito, Machida-shi (JP); Kensuke Masuda, Kawasaki-shi (JP); Hiroyuki Satoh, Yokohama-shi (JP); Yoshiaki Irino, Kawasaki-shi (JP); Tomonori Tanaka, Yokohama-shi (JP); Nozomi Imae, Yokohama-shi (JP); Hideaki Yamamoto, Yokohama-shi (JP); Satoshi Sawaguchi, Yokohama-shi (JP); Daisuke Bessho, Kawasaki-shi (JP); Shusaku Takasu, Yokohama-shi (JP)

(72) Inventors: Makoto SHOHARA, Hachioji-shi (JP); Toru Harada, Kawasaki-shi (JP); Hirokazu Takenaka, Kawasaki-shi (JP); Yoichi Ito, Machida-shi (JP); Kensuke Masuda, Kawasaki-shi (JP); Hiroyuki Satoh, Yokohama-shi (JP); Yoshiaki Irino, Kawasaki-shi (JP); Tomonori Tanaka, Yokohama-shi (JP); Nozomi Imae, Yokohama-shi (JP); Hideaki Yamamoto, Yokohama-shi (JP); Satoshi Sawaguchi, Yokohama-shi (JP); Daisuke Bessho, Kawasaki-shi (JP); Shusaku Takasu, Yokohama-shi (JP)

(21) Appl. No.: 14/024,997

(22) Filed: Sep. 12, 2013

(30) Foreign Application Priority Data
Sep. 18, 2012 (JP) 2012-204474
Jul. 5, 2013 (JP) 2013-141549

(51) Int. Cl. H04N 9/73

(52) U.S. Cl. CPC H04N 9/735
USPC 348/38

(57) ABSTRACT

An image adjuster includes an area evaluator to calculate an area evaluation value for each color in each of divided areas of each of images captured by a plurality of imaging units, a brightness adjuster to calculate a brightness adjustment value for overlapping divided areas between photographic areas of the images on the basis of the area evaluation value for each color, and an adjustment value calculator to calculate a balance adjustment value for each of the overlapping divided areas from the area evaluation value for each color on the basis of the brightness adjustment value.

### CROSS REFERENCE TO RELATED APPLICATION

The present application is based on and claims priority from Japanese Patent Application No. 2012-204474, filed on Sep. 18, 2012 and No. 2013-141549, filed on Jul. 5, 2013.

### BACKGROUND OF THE INVENTION

1. Field of the Invention

The present invention relates to an image adjuster which is able to properly adjust the condition of captured images, an image adjusting method executed by such an image adjuster and a program to realize such an image adjusting method.

2. Description of the Related Art

The white balance correction of a camera is a function to adjust white color so that a white object appears white in an image under various kinds of illuminants. Without white balance correction, a natural white color the human eyes see may appear unnatural on a captured image and an image in proper color shades cannot be generated. It is known that a digital camera comprises a function to acquire a good white balance from a captured image.

There is a known omnidirectional imaging system which includes multiple wide-angle lenses such as fisheye lens or super wide-angle lens to capture an image in omnidirections at once. It is configured to project images from the lenses onto a sensor surface and combine the images through image processing to thereby generate an omnidirectional image. For example, by use of two wide-angle lenses with angle of view of over 180 degrees, omnidirectional images can be generated.

However, such a known white balance adjustment cannot apply to panorama or omnidirectional photographing with an imaging system including multiple imaging units since it is difficult to acquire proper white balance while connecting the captured images appropriately due to different optical conditions of the imaging units.

Japanese Patent Application Publication No. 2009-17457 discloses a fly-eye imaging device with white balance correction which calculates the RGB gains of sub imaging units virtually equivalent to the white balance adjustment of a main unit according to a calculated white balance evaluation value of the main unit, relative sensitivity values to RGB pre-stored in the imaging device, and a sensitivity constant.

However, it cannot acquire a proper white balance value if the optical conditions of the imaging units vary, because it calculates the color gains of the sub imaging units from the white balance evaluation value of the main imaging unit.

In particular, with an omnidirectional camera having an omnidirectional imaging area, the scene captured with two cameras is often illuminated with different illuminants, which is likely to cause a difference in the colors of image connecting portions. Setting a proper white balance for the individual imaging units cannot resolve a difference in the brightness of the connecting portions, which may impair the quality of an omnidirectional image.

### SUMMARY OF THE INVENTION

The present invention aims to provide an image adjuster and image adjusting control method and program which can abate a discontinuity at the connecting points of images in synthesizing the images.

According to one aspect of the present invention, an image adjuster which provides an adjustment condition to an image, comprises an area evaluator to calculate an area evaluation value for each color in each of divided areas of each of images captured by a plurality of imaging units, a brightness adjuster to calculate a brightness adjustment value for overlapping divided areas between photographic areas of the images on the basis of the area evaluation value for each color, and an adjustment value calculator to calculate a balance adjustment value for each of the overlapping divided areas from the area evaluation value for each color on the basis of the brightness adjustment value.

### BRIEF DESCRIPTION OF THE DRAWINGS

Features, embodiments, and advantages of the present invention will become apparent from the following detailed description with reference to the accompanying drawings:

FIG. 1 is a cross section view of an omnidirectional imaging system according to the present embodiment;

FIG. 2 shows the hardware configuration of the omnidirectional imaging system in FIG. 1;

FIG. 3 shows a flow of the entire image processing of the omnidirectional imaging system in FIG. 1;

FIGS. 4A, 4B show the images captured by two fisheye lenses, respectively and FIG. 4C shows a synthetic image of the captured images by way of example;

FIGS. 5A, 5B show an area division method according to the present embodiment;

FIG. 6 is a flowchart for the white balance adjustment executed by the omnidirectional imaging system according to the present embodiment; and

FIG. 7 is a flowchart for the area white balance calculation executed by the omnidirectional imaging system according to the present embodiment; and

FIG. 8 shows how to estimate an illuminant on the basis of blackbody radiation trajectory.

### DETAILED DESCRIPTION OF THE PREFERRED EMBODIMENT

Hereinafter, an embodiment of an image adjuster will be described in detail with reference to the accompanying drawings. Wherever possible, the same reference numbers will be used throughout the drawings to refer to the same or like parts. By way of example, the present embodiment describes an omnidirectional imaging system 10 which comprises a function to decide an image adjusting condition on the basis of images captured by two fisheye lenses. Alternatively, the omnidirectional imaging system can comprise a camera unit including three or more lenses to determine an image adjusting condition according to the images captured by the three or more lenses. By use of three or more lenses, the angle of view can be set so that the imaging areas of these lenses overlap. Herein, a fisheye lens can include a wide-angle lens or a super wide-angle lens.

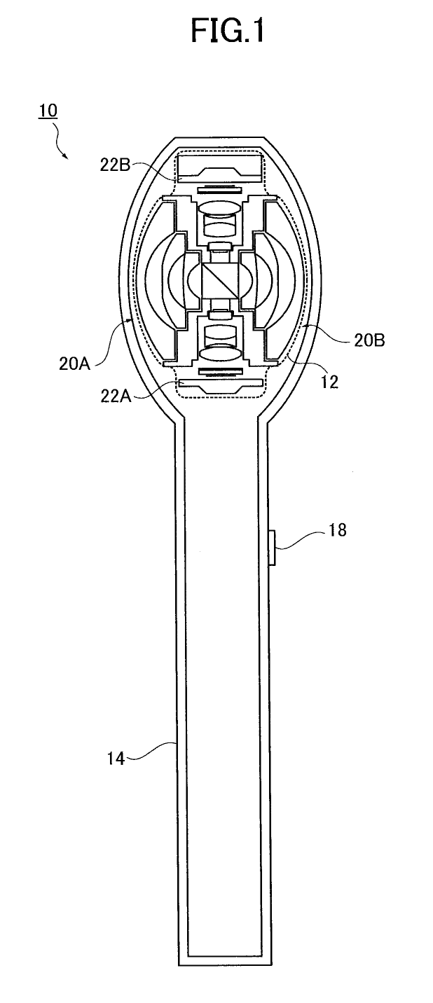

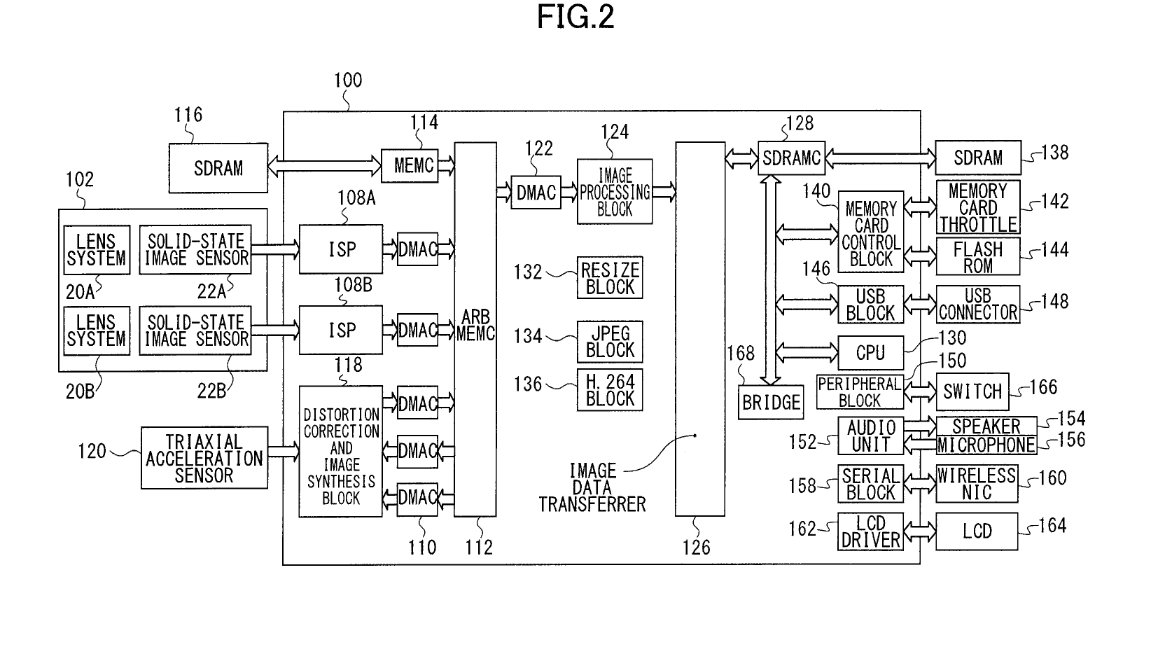

Referring to FIGS. 1 to 2, the overall configuration of the omnidirectional imaging system 10 is described. FIG. 1 is a cross section view of the omnidirectional imaging system 10 (hereinafter, simply, imaging system). It comprises a camera unit 12, a housing 14 accommodating the camera unit 12 and elements as controller, batteries, and a shutter button 18 provided on the housing 14.

The camera unit 12 in FIG. 1 comprises two lens systems 20A, 20B and two solid-state image sensors 22A, 22B as CCD (charge coupled device) sensor or CMOS (complementary metal oxide semiconductor). Herein, each of the pairs of the lens systems 20 and solid-state image sensors 22 are referred to as imaging unit. The lens systems 20A, 20B are each comprised of 6 groups of 7 lenses as a fisheye lens, for instance. In the present embodiment the fisheye lens has total angle of view of 180 degrees (360 degrees/n, n=2) or more, preferably 185 degrees or more, more preferably 190 degrees or more.

The optical elements as lenses, prisms, filters, aperture stops of the lens systems 20A, 20B are positioned relative to the solid-state image sensors 22A, 22B so that the optical axes of the optical elements are orthogonal to the centers of the light receiving areas of the corresponding solid-state image sensors 22 as well as the light receiving areas become the imaging planes of the corresponding fisheye lenses. The solid-state image sensors 22 are area image sensors on which photodiodes are two-dimensionally arranged, to convert light gathered by the lens systems 20 to image signals.

In the present embodiment the lens systems 20A, 20B are the same and disposed opposite to each other so that their optical axes coincide. The solid-state image sensors 22A, 22B convert light distribution to image signals and output them to a not-shown image processor on the controller. The image processor combines images from the solid-state image sensors 22A, 22B to generate a synthetic image with solid angle of 4π in radian or an omnidirectional image. The omnidirectional image is captured in all the directions which can be seen from a shooting point. Instead of the omnidirectional image, a panorama image which is captured in a 360-degree range only on a horizontal plane can be generated.

To form an omnidirectional image with use of the fisheye lenses with total angle of view of more than 180 degrees, an overlapping portion of the captured images by the imaging units is used for connecting images as reference data representing the same image. Generated omnidirectional images are output to, for instance, a display provided in or connected to the camera unit 12, a printer, or an external storage medium such as SD Card®, Compact Flash®.

FIG. 2 shows the structure of hardware of the imaging system 10 according to the present embodiment. The imaging system 10 comprises a digital still camera processor 100 (hereinafter, simply processor), a lens barrel unit 102, and various elements connected with the processor 100. The lens barrel unit 102 includes the two pairs of lens systems 20A, 20B and solid-state image sensors 22A, 22B. The solid-state image sensors 22A, 22B are controlled by a command from a CPU 130 of the processor 100.

The processor 100 comprises ISPs (image signal processors) 108A, 108B, a DMAC (direct memory access controller) 110, an arbiter (ARBMEMC) 112 for memory access, a MEMC (memory controller) 114 for memory access, and a distortion correction and image synthesis block 118. The ISPs 108A, 108B perform automatic exposure control to and set white balance and gamma balance of image data signal-processed by the solid-state image sensors 22A, 22B.

The MEMC 114 is connected to an SDRAM 116 which temporarily stores data used in the processing of the ISPs 108A, 108B and distortion correction and image synthesis block 118. The distortion correction and image synthesis block 118 performs distortion correction and vertical inclination correction on the two images from the two imaging units on the basis of information from a triaxial acceleration sensor 120 and synthesizes them.

The processor 100 further comprises a DMAC 122, an image processing block 124, a CPU 130, an image data transferrer 126, an SDRAMC 128, a memory card control block 140, a USB block 146, a peripheral block 150, an audio unit 152, a serial block 158, an LCD (Liquid Crystal Display) driver 162, and a bridge 168.

The CPU 130 controls the operations of the elements of the imaging system 10. The image processing block 124 performs various kinds of image processing on image data. A resize block 132 enlarges or shrinks the size of image data by interpolation. A JPEG block 134 is a codec block to compress and decompress image data in JPEG. A H.264 block 136 is a codec block to compress and decompress video data in H.264. The image data transferrer 126 transfers the images processed by the image processing block 124. The SDRAMC 128 controls the SDRAM 138 connected to the processor 100 and temporarily storing image data during image processing by the processor 100.

The memory card control block 140 controls data read and write to a memory card and a flash ROM 144 inserted to a memory card throttle 142 in which a memory card is detachably inserted. The USB block 146 controls USB communication with an external device such as personal computer connected via a USB connector 148. The peripheral block 150 is connected to a power switch 166.

The audio unit 152 is connected to a microphone 156 for receiving an audio signal from a user and a speaker 154 for outputting the audio signal, to control audio input and output. The serial block 158 controls serial communication with the external device and is connected to a wireless NIC (network interface card) 160. The LCD driver 162 is a drive circuit for the LCD 164 and converts the image data to signals for displaying various kinds of information on an LCD 164.

The flash ROM 144 contains a control program written in readable codes by the CPU 130 and various kinds of parameters. Upon power-on of the power switch 166, the control program is loaded onto a main memory. The CPU 130 controls the operations of the units and elements of the image processor in compliance with the control program on the main memory, and temporarily stores necessary control data in the SDRAM 138 and a not-shown local SRAM.

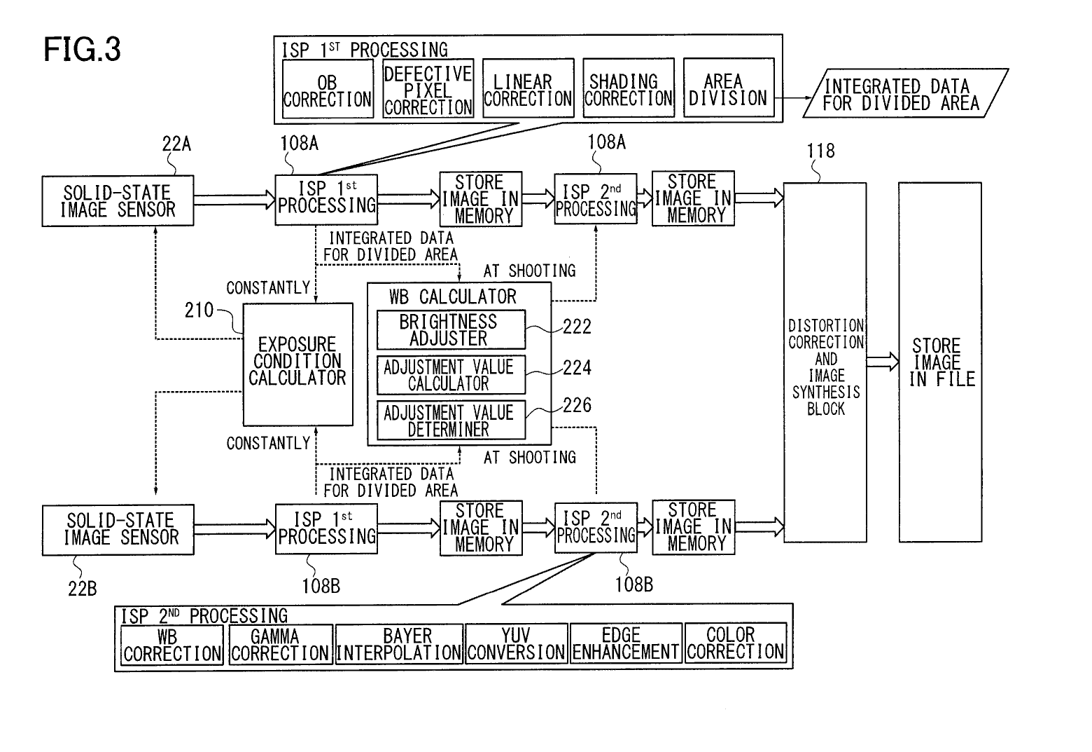

FIG. 3 shows essential function blocks for controlling image adjusting condition and the flow of the entire image processing of the imaging system 10 according to the present embodiment. First, the solid-state image sensors 22A, 22B capture images under a certain exposure condition and output them. The exposure condition is determined by an exposure condition calculator and set for the solid-state image sensors 22A, 22B.

Then, the ISPs 108A, 108B in FIG. 2 perform optical black correction, defective pixel correction, linear correction, shading correction and area division (collectively referred to as first processing) to the images from the solid-state image sensors 22A, 22B and store them in memory.

The optical black correction is a processing in which an output signal from an effective pixel area is subjected to clamp correction, using the output signals of optical black areas of the solid-state image sensors as a black reference level. A solid-state image sensor such as CMOS may contain defective pixels from which pixels values are not obtainable because of impurities entering a semiconductor substrate in the manufacturing of the image sensor. The defective pixel correction is a processing in which the value of a defective pixel is corrected according to a combined signal from neighboring pixels of the defective pixel.

The linear correction is for each of RGBs. Brightness unevenness occurs on the sensor surface due to the characteristic of an optical or imaging system, for example, peripheral light extinction of an optical system. The shading correction is to correct a distortion of shading in an effective pixel area by multiplying the output signal of the effective pixel area by a certain correction coefficient so as to generate an image with uniform brightness. Sensitivity of each area can be corrected by applying different coefficients thereto depending on a color.

Preferably, in the linear correction, shading correction, or the other process sensitivity correction for each of RGB can be additionally conducted on the basis of a gray chart captured under a certain illuminant (D65, for example) with a reference camera, for the purpose of adjusting individual differences between the image sensors. The adjustment gains (T_{Ri}, T_{Gi}, T_{Bi}) of an i-th image sensor (iε{1, 2}) are calculated by the following equations:

T_{Ri}=P_{Ri}/P_{R0}

T_{Gi}=P_{Gi}/P_{G0}

T_{Ri}=P_{Bi}/P_{B0}

where P_{R0}, P_{G0}, P_{B0} are RGB gains when gray color is shot under D65 with a reference camera. The solid-state image sensors 22A, 22B are represented by indexes 1 and 2, respectively, for example.

By applying the adjustment gains to the obtained pixel values and adjusting a difference in the sensitivities of the image sensors, plural images can be dealt with as a single image. In the area division each image is divided into small areas and an integrated value or integrated average value is calculated for each divided area.

Returning to FIG. 3, after the first processing the ISPs 108A, 108B further perform white balance, gamma correction, Bayer interpolation, YUV conversion, edge enhancement and color correction (collectively referred to as second processing) to the images, and the images are stored in the memory.

The amount of light transmitting through the color filters of the image sensors differs depending on the color of the filter. The white balance correction is to correct a difference in sensitivity to the three colors R (red), G (green), and B (blue) and set a gain for appropriately representing white color in an image. Also, the color of a subject changes depending on an illuminant as sunlight, fluorescent light. In white balance correction an appropriate gain is set even with a change of an illuminant. A WB (white balance) calculator 220 calculates a white balance parameter according to the RGB integrated value or integrated average value calculated in the area division process. The gamma correction is to correct a gamma value of an input signal so that the output linearity of an output device is maintained with the characteristic thereof taken into account.

Further, in the CMOS each pixel is attached with any of RGB color filters. The Bayer interpolation is to interpolate insufficient two colors from neighboring pixels. The YUV conversion is to convert RAW data in RGB format to data in YUV format of a brightness signal Y and a color difference signal UV. The edge enhancement is to extract the edges of an image according to a brightness signal, apply a gain to the edges, and remove noise from the image in parallel to the edge extraction. The color correction includes chroma setting, hue setting, partial hue change, and color suppression.

After the various kinds of processing to the captured images under a certain condition, the images are subjected to distortion correction and image synthesis. A generated omnidirectional image is added with a tag properly and stored in a file in the internal memory or an external storage. Vertical inclination correction can be additionally performed on the basis of the information from the triaxial acceleration sensor 120 or a stored image file can be subjected to compression when appropriate. A thumb-nail image can be generated by cropping or cutting out the center area of an image.

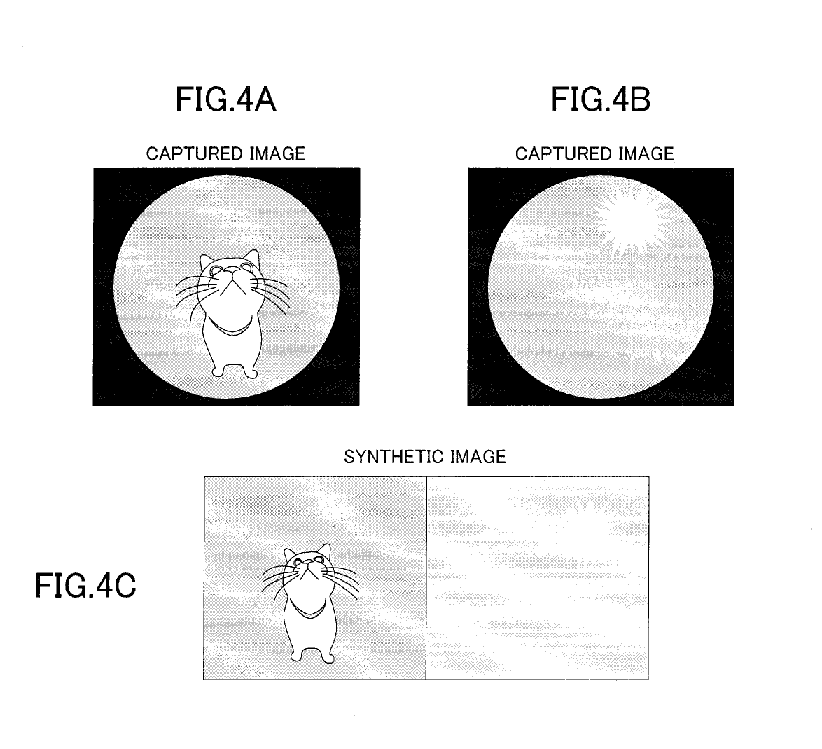

In omnidirectional photographing with the omnidirectional imaging system 10, the two imaging units generate two images. In a photographic scene including a high-brightness object as the sun, a flare may occur in one of the images as shown in FIGS. 4A, 4B and spread over the entire image from the high-brightness object. In such a case a synthetic image of the two images or omnidirectional image may be impaired in quality because a difference in color at the connecting portions occurs. FIG. 4C shows a difference in gray tone. Further, no proper object for white balance adjustment such as a gray object will appear in the border area of the two images.

In the imaging unit using fisheye lenses with total angle of view of over 180 degrees most of photographic areas do not overlap except for a partial overlapping area. Because of this, it is difficult to acquire a proper white balance for the above scene by adjusting a white balance based only on the overlapping area. Further, even with the proper white balance obtained for the individual imaging units, a discontinuity of color may occur at the connecting positions of a synthetic image.

In view of avoiding insufficient white balance adjustment, in the imaging system 10 the white balance calculator 220 is configured to calculate a brightness adjustment value according to the RGB integrated values of each overlapping divided area and determine a WB adjustment value for each divided area on the basis of the calculated brightness adjustment value. Specifically, the white balance calculator 220 comprises a brightness adjuster 222, an adjustment value calculator 224, and an adjustment value determiner 226, and can be realized by the ISPs 108 and CPU 130.

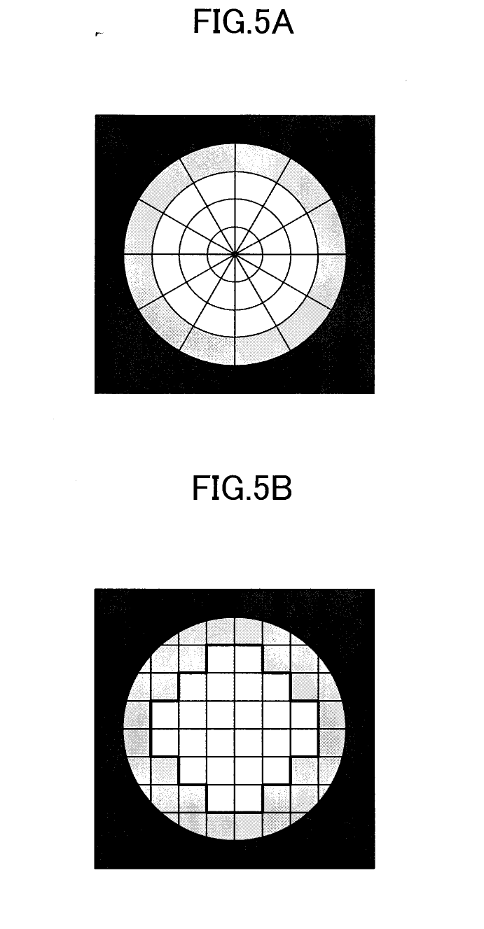

FIGS. 5A, 5B show how to divide an image into small areas by way of example. In the present embodiment incident light on the lens systems 20A, 20B is imaged on the light-receiving areas of the solid-state image sensors 22A, 22B in accordance with a certain projection model such as equidistant projection. Images are captured on the two-dimensional solid-state area image sensors and image data represented in a plane coordinate system. In the present embodiment a circular fisheye lens having an image circle diameter smaller than an image diagonal line is used and an obtained image is a planar image including the entire image circle in which the photographic areas in FIGS. 4A, 4B are projected.

The entire image captured by each solid-state image sensor is divided into small areas in circular polar coordinate system with radius r and argument θ in FIG. 5A or small areas in planar orthogonal coordinate system with x and y coordinates in FIG. 5B. It is preferable to exclude the outside of the image circle from a subject of integration and averaging since it is a non-exposed outside area. The outside area can be used for an optical black area to calculate an optical black (hereinafter, OB) value (o₁, o₂) for each image sensor according to an integrated value of a divided area corresponding to the outside area. The OB value is used in calculating a WB correction value. It can be a collective RGB value for each image sensor or individual values for each of RGB to absorb a difference in the three colors. In FIGS. 5A, 5B the middle gray area is an overlapping area between the images corresponding to the total angle of view of over 180 degrees.

In the area division of the ISPs 108, each image is divided into small areas as shown in FIGS. 5A, 5B and the integrated value or integrated average value of each of RGB is calculated for each divided area. The integrated value is obtained by integrating the pixel values of each RGB color in each divided area while the integrated average value is obtained by normalizing the integrated value with the size (number of pixels) of each divided area excluding the outside area. An area evaluation value as integrated value or integrated average value for each RGB color of each divided area is calculated from RAW image data and output as integrated data.

The brightness adjuster 222 receives the integrated data obtained by the ISPs 108A, 108B, and calculates a brightness adjustment value for an overlapping divided area (hereinafter, may be referred to as overlapping area) between the images according to each of RGB integrated values. Herein, the integrated value for each divided area corresponds to the overlapping area and satisfies a certain criteria.

The brightness adjuster 222 calculates a brightness value of each overlapping area on the basis of each RGB integrated value and calculates a gain value for each image sensor as the brightness adjustment value according to a difference in the largest brightness values of all the overlapping areas of the two images. Moreover, it calculates an offset correction value as the brightness adjustment value for each image sensor on the basis of a difference in the smallest brightness values of the overlapping areas of the two images.

The adjustment value calculator 224 adjusts each RGB integrated value for each overlapping area according to the brightness adjustment values as gain value and offset correction value and calculates a candidate of WB adjustment value for each overlapping area, as described later.

The adjustment value determiner 226 applies weighted averaging to the WB adjustment value in the periphery of each overlapping area including a non-overlapping area on the basis of the candidate of WB adjustment value, to determine a smoothed WB adjustment value. It can change the weights of the weighted averaging in accordance with a difference in the WB adjustment values between the overlapping area and a non-overlapping area. Since the overlapping area is a relatively small area, there is a limitation to the accuracy of the WB adjustment value. It is made possible to avoid extremely different adjustment values from being set for the overlapping divided areas by applying a smaller weight to the divided areas having a large difference.

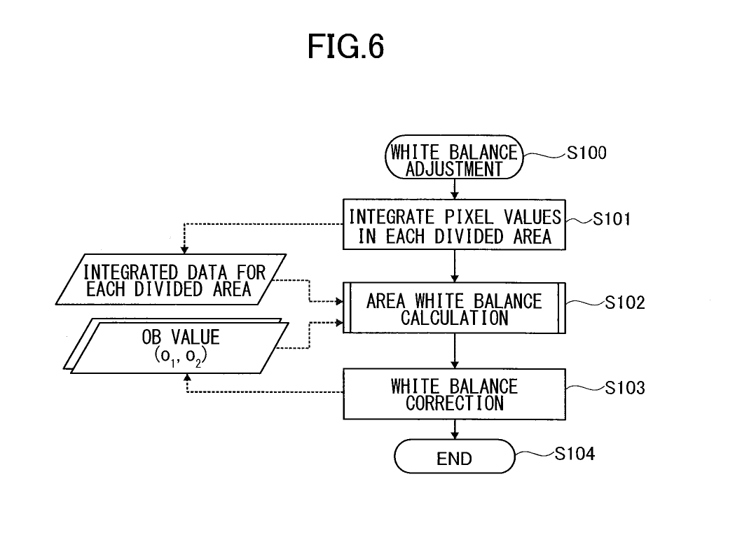

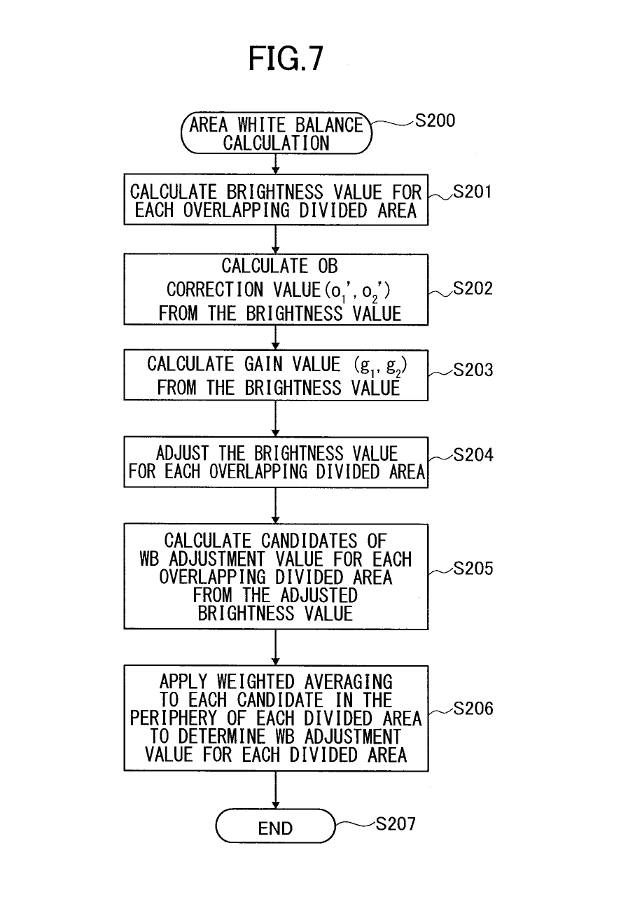

Now, the white balance adjustment executed by the imaging system 10 is described referring to FIGS. 6 and 7. FIG. 6 is a flowchart for white balance calculation process while FIG. 7 is a flowchart for area white balance calculation process.

Referring to FIG. 6, in step S101 the imaging system 10 integrates the pixel values of each divided area and obtains, for each of the two solid-state image sensors 22A, 22B, an integrated average value of each of RGB for each divided area. In step S102 the area white balance calculation in FIG. 7 is called up, to calculate a WB correction value for each divided area from the integrated data calculated in step S101 and an OB value (o₁, o₂) for each image sensor.

Referring to FIG. 7, in step S201 the brightness adjuster 222 finds a brightness value mᵢ(x,y) for each divided area for each image sensor by weighted averaging to the integrated value calculated in step S101 by the following equations (1) and (2). The index i (iε{1,2}) identifies the solid-state image sensors 22A, 22B. wbR₀, wbG₀, wbB₀ are predefined white balance gains for each of RGB colors. avRᵢ(x,y), avGᵢ(x,y), and avBᵢ(x,y) are RGB integrated values for a divided area (x,y) of an image sensor i.

m₁(x,y)=wbR₀*avR₁(x,y)+wbG₀*avG₁(x,y)+wbB₀*avB₁(x,y), where (x,y)εoverlapping area &th_{L}<avR₁(x,y),avG₁(x,y),avB₁(x,y)<th_{U} (1)

m₂(x,y)=wbR₀*aR₂(x,y)+wbG₀*avG₁(x,y)+wbB₀*avB₂(x,y), where (x,y)εoverlapping area &th_{L}<avR₂(x,y),avG₂(x,y),avB₂(x,y)<th_{U} (2)

By these equations, weighted average is calculated for the divided area (x, y) of each image sensor which satisfies the condition that it is an overlapping area and the integrated value falls within a certain range of over a lower limit value thL and less than an upper limit value thU.

The predefined white balance gains wbR₀, wbG₀, wbB₀ can be prepared depending on the characteristic of an imaging unit on the basis of a gray chart shot under a certain illuminant (D65, for example). Assumed that the pixel value obtained from the gray chart is sₖ (kε{R,G,B}), white balance gain wbₖ (kε{R,G,B}) is calculated by the following equation:

$${wb}_{k} = \frac{{S}_{G}}{{S}_{k}}$$

Thus, the found white balance gain wbₖ (kε{R,G,B}) is set as the predefined white balance gains wbR₀, wbG₀, wbB₀.

Alternatively, the predefined white balance gains wbR₀, wbG₀, wbB₀ can be determined by a known automatic white balance processing such as gray world algorithm, algorithm (Max-RGB) based on Retinex theory, or algorithm based on illuminant estmation.

Gray world algorithm is based on the assumption that the average of the R, G, and B components of the image should be achromatic color. It determines a white balance gain such that the average signal levels of RGB become equal in a certain image area. The white balance gain wbₖ (kε{R,G,B}) can be calculated by the following equations from the average value aveₖ (kε{R,G,B}) of the pixel values sₖ (kε{R,G,B}) of the entire image (M*N[pix]). Herein, the entire image captured by the fisheye lens refers to the whole area in the image circle illuminated with light.

$${ave}_{k} = \frac{{\sum }_{x}^{ } {\sum }_{y}^{ } {S}_{k}}{MN}$$

$${wb}_{k} = \frac{{ave}_{G}}{{ave}_{k}}$$

By gray world algorithm appropriate white balance gains can be found for most of common scenes according to a minimal value wb_{BLim} of a blue gain wb_{B}. In the omnidirectional imaging system 10 it is unlikely that the entire image (4π steradian) turns a certain color. Therefore, the gray world algorithm will hold true for the most scenes by adding a limit to a blue color as follows:

$${wb}_{B} = \{ \begin{matrix}{ave}_{G} / {ave}_{B} & {ave}_{G} / {ave}_{B} > {wb}_{BLim} \\ {wb}_{BLim} & {ave}_{G} / {ave}_{B} \leq {wb}_{BLim} .\end{matrix}$$

The algorithm based on Retinex theory is based on the theory that white color perceived by the human eyes is determined by a maximal cone signal. An image is captured on a solid-state image sensor without saturation, and white balance gain can be calculated by the following equation from a pixel value (s_{R}, s_{G}, s_{B}) at a position having a maximal value of any of RGB.

$${wb}_{k} = \frac{{S}_{G}}{{S}_{k}}$$

The algorithm based on illuminant estimation is to obtain illuminant information by extracting an estimated achromatic region from a subject image on the basis of known illuminant information. For instance, a known illuminant with a closest center of gravity is decided by the observation of a distribution of pixel values on the Cr-Cb plane.

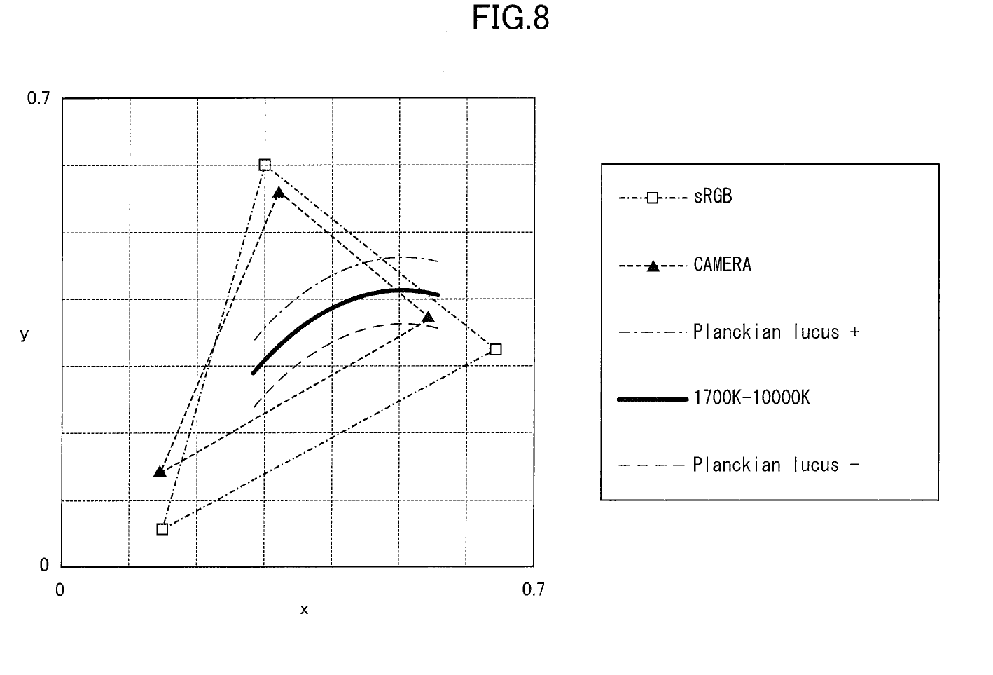

Further, the dispersion of general illumination is distributed around blackbody radiation trajectory. Therefore, an illuminant can be estimated from data in an illuminant frame surrounding blackbody radiation trajectory in a color space. FIG. 8 is an xy chromaticity diagram showing blackbody radiation trajectory. In the drawing sRGB (standard RGB) area is indicated by the small square and the spectral characteristic of a camera is indicated by the black triangle. The center of blackbody radiation trajectory is represented by the solid line while the upper and lower limit values are represented by the chain and dot line and broken line, respectively.

The white balance gain can be decided from a result of illuminant estimation. A fixed value of white balance gain can be decided for each of estimated illuminants or an intermediate value can be interpolated from the distribution of data in the illuminant frame. For simplicity the pixel values inside the area (illuminant frame) surrounded by the chain and dot line and broken line can be averaged.

The wbₖ (kε{R,G,B}) obtained by any of the known algorithms can be set as the predefined white balance gain wbR₀, wbG₀, wbB₀. The white balance gain can be separately determined for the solid-state image sensors 22A, 22B by the above equations (1) and (2) instead of commonly.

In step S202 the brightness adjuster 222 calculates an OB correction value (o₁′, o₂′) for each of the image sensors from the OB value (o₁, o₂) given from the brightness adjuster 222 and the brightness values m₁(x, y) and m₂(x, y) for each overlapping area of each image sensor (iε{1,2}). The OB correction value (o₁′, o₂′) is suitably used if the brightness of the imaging units cannot be sufficiently adjusted by automatic exposure control, and calculated by the following equations:

$$\begin{matrix}\begin{matrix}\begin{matrix}\begin{matrix}\begin{matrix}ob = min ( min ( {m}_{1} ( x , y ) ) , min ( {m}_{2} ( x , y ) ) ) \\ ot = max ( min ( {m}_{1} ( x , y ) ) , min ( {m}_{2} ( x , y ) ) )\end{matrix} \\ {do}_{1} = ot - min ( {m}_{1} ( x , y ) )\end{matrix} \\ {do}_{2} = ot - min ( {m}_{2} ( x , y ) )\end{matrix} \\ {o}_{1}^{′} = {o}_{1} + {do}_{1}\end{matrix} \\ {o}_{2}^{′} = {o}_{2} + {do}_{2}\end{matrix} \} \qquad ( 3 )$$

The function min is to find a minimal value of a given set while the function max is to find a maximal value of a given set.

By the equations (3), the OB value for one of the image sensors with a smaller smallest brightness value of the overlapping area is increased to that for the other image sensor with a larger smallest brightness value according to a difference in the smallest brightness values of the overlapping areas of the captured images. For example, if the smallest brightness value of the solid-state image sensor 22A is larger than that of the solid-state image sensor 22B (min (m₁(x, y))>min (m₂(x,y))), the OB correction value o₂′ for the solid-state image sensor 22B is increased by the difference and the OB correction value o₁′ for the solid-state image sensor 22A is not changed.

In step S203 the brightness adjuster 222 further calculates a gain value (g₁, g₂) for each image sensor from the brightness values m₁(x, y) and m₂(x, y) of the overlapping areas by the following equations (4):

$$\begin{matrix}\begin{matrix}\begin{matrix}\begin{matrix}{mt}_{1} ( x , y ) = {m}_{1} ( x , y ) - min ( {m}_{1} ( x , y ) ) \\ {mt}_{2} ( x , y ) = {m}_{2} ( x , y ) - min ( {m}_{2} ( x , y ) )\end{matrix} \\ ma = max ( max ( {mt}_{1} ( x , y ) ) , max ( {mt}_{2} ( x , y ) ) )\end{matrix} \\ {g}_{1} = ma / max ( {mt}_{1} ( x , y ) )\end{matrix} \\ {g}_{2} = ma / max ( {mt}_{2} ( x , y ) )\end{matrix} \} \qquad ( 4 )$$

By the above equations (4), the gain value for one of the image sensors which has captured the overall overlapping area with a smaller largest brightness value (subtracted of min (m₁(x, y))) is increased to be larger than that for the other image sensor with a larger largest brightness value according to a difference in the largest brightness values of the overlapping divided areas of the captured images. For example, if the largest brightness value of the solid-state image sensor 22A is larger than that of the solid-state image sensor 22B (max (mt₁(x, y))>max (mt₂(x,y))), the gain value g₂ for the solid-state image sensor 22B is increased by the ratio and the gain value g₁ for the solid-state image sensor 22A is 1.

In step S204 the adjustment value calculator 224 adjusts the brightness value mᵢ(x, y) on the basis of the above brightness adjustment value. The adjusted brightness value mᵢ′(x, y) is calculated by the following equations:

$$\begin{matrix}{m}_{1}^{′} ( x , y ) = ( {mt}_{1} ( x , y ) * {g}_{1} ) + ob \\ {m}_{2}^{′} ( x , y ) = ( {mt}_{2} ( x , y ) * {g}_{2} ) + ob\end{matrix} \} \qquad ( 5 )$$

In step S205 the adjustment value calculator 224 calculates candidates of the WB adjustment value for each overlapping area from the adjusted brightness value mᵢ′(x, y). The candidates (wbrᵢ(x, y), wbgᵢ(x, y), wbbᵢ(x,y)) are calculated by the following equations:

$$\begin{matrix}\begin{matrix}\begin{matrix}\begin{matrix}\begin{matrix}{avR}_{i}^{′} ( x , y ) = {avR}_{i} ( x , y ) * {m}_{i}^{′} ( x , y ) / {m}_{i} ( x , y ) \\ {avG}_{i}^{′} ( x , y ) = {avG}_{i} ( x , y ) * {m}_{i}^{′} ( x , y ) / {m}_{i} ( x , y )\end{matrix} \\ {avB}_{i}^{′} ( x , y ) = {avB}_{i} ( x , y ) * {m}_{i}^{′} ( x , y ) / {m}_{i} ( x , y )\end{matrix} \\ {wbr}_{i} ( x , y ) = ( {avG}_{i}^{′} - {o}_{i}^{′} ) / ( {avR}_{i}^{′} - {o}_{i}^{′} )\end{matrix} \\ {wbg}_{i} ( x , y ) = 1.0\end{matrix} \\ {wbb}_{i} ( x , y ) = ( {avG}_{i}^{′} - {o}_{i}^{′} ) / ( {avB}_{i}^{′} - {o}_{i}^{′} )\end{matrix} \} \qquad ( 6 )$$

In step S206 the adjustment value determiner 226 applies weighted averaging to the calculated candidates (wbrᵢ(x, y), wbgᵢ(x, y), wbbᵢ(x,y)) in the periphery of each divided area including the non-overlapping area to determine the WB adjustment value (wbRᵢ(x, y), wbGᵢ(x, y), wbBᵢ(x,y)) for each overlapping areas. The WB adjustment value is calculated by the following equation, taking a red gain wbRᵢ(x, y) for example:

$${wbR}_{i} ( x , y ) = {{\sum }_{u}^{ } {\sum }_{v}^{ } r ( x , y , u , v ) * {wbr}_{i} ( x + u , y + v )}_{{\sum }_{u}^{ } {\sum }_{v}^{ } r ( x , y , u , v )} \\ where \\ r ( x , y , u , v ) = \{ \begin{matrix}exp ( \begin{matrix}- {( {wbr}_{i} ( x , y ) - {wbr}_{i} ( x + u , y + v ) )}^{2} \\ {{wbr}_{i} ( x + u , y + v ) )}^{2}\end{matrix} ) & \\ * exp ( \begin{matrix}- {( {wbb}_{i} ( x , y ) - {wbb}_{i} ( x + u , y + v ) )}^{2} \\ {{wbb}_{i} ( x + u , y + v ) )}^{2}\end{matrix} ) , & \begin{matrix}( x , y ) ∈ overlapping area \\ ‖ ( x + u , y + v ) ∈ overlapping area\end{matrix} \\ 1 , & else\end{matrix} \qquad ( 7 )$$

In the equation (7) u and v identify a surrounding area around a divided area (x, y). The range of u and v for weighted averaging can be arbitrarily set. Further, the WB adjustment value (wbrᵢ(x, y), wbgᵢ(x, y), wbbᵢ(x, y); iε{1,2}) for each non-overlapping divided area can be the predefined WB value found by the known automatic white balance processing. However, it should not be limited thereto.

For instance, in a wide area excluding the overlapping area a set of WB adjustment values for a single correction point for each image sensor can be determined by the gray world algorithm, and interpolated to be suitable for the mesh form of the divided areas. Thereby, the WB adjustment value for each divided area (x, y) can be calculated. In replace of the gray world algorithm, the algorithms based on Retinex theory and illuminant estimation can be used. Alternatively, multiple correction points can be set for each image sensor. Preferably, in adjusting the sensitivities of the individual image sensors, the light receiving areas of the image sensors are collectively regarded as one image and one or more target points can be set therefor.

In the weighed averaging of the equation (7) Gauss function gives a smaller weight r to the candidate in the peripheral divided areas when the difference between the WB adjustment values of the overlapping area and non-overlapping area is large. A gain for the overlapping area extremely different from that for the non-overlapping area is likely to be inaccurate. By setting a small weight to that area, an anomaly value can be properly adjusted.

The operation completes when the WB adjustment value for each divided area is determined. Returning to step S103 in FIG. 6, the WB adjustment value is updated to the determined one in the registers of the ISPs 108A, 108B and the white balance of each divided area is corrected, completing the operation.

As described above, it is made possible to provide an image adjuster and imaging adjusting method and program which can abate a discontinuity of color at the connecting points of the images captured by the imaging units in synthesizing the images.

In view of the occurrence of flares in one of the images as shown in FIGS. 4A, 4B captured by omnidirectional photographing with the omnidirectional imaging system 10, according to the present embodiment the brightness adjustment value is calculated on the basis of the RGB integrated values for each overlapping area to determine the WB adjustment value for each overlapping area on the basis of the calculated brightness adjustment value. Thereby, it is made possible to abate a discontinuity of color at the connecting positions of a synthetic image and generate high-quality synthetic images.

Further, the adjustment gains are preferably calculated for each image sensor and the adjustment gains (T_{Ri}, T_{Gi}, T_{Bi}) are added to the pixel values using a reference camera as a reference. Thus, a difference in the sensitivities of the image sensors can be adjusted, reducing the discontinuity of color at the connecting positions of the captured images.

The above embodiment has described an example where two images captured with the two image sensors via the lens systems having angle of view of over 180 degrees are overlapped for synthesis. Alternatively, three or more images captured with three or more image sensors can be overlapped for synthesis. Further, an omnidirectional imaging system having multiple lenses and solid-state image sensors can be realized instead of the imaging system with the fisheye lenses.

Moreover, the above embodiment has described the imaging system 10 to capture an omnidirectional still image as an example of the image adjuster.

The present invention should not be limited to such an example. Alternatively, the imaging adjuster can be configured as an omnidirectional video imaging system or unit, a portable data terminal such as a smart phone or tablet having an omnidirectional shooting function, or a digital still camera processor or a controller to control a camera unit of an imaging system.

The functions of the omnidirectional imaging system can be realized by a computer-executable program written in legacy programming language such as assembler, C, C++, C#, JAVA® or object-oriented programming language. Such a program can be stored in a storage medium such as ROM, EEPROM, EPROM, flash memory, flexible disc, CD-ROM, CD-RW, DVD-ROM, DVD-RAM, DVD-RW, blue ray disc, SD card, or MO and distributed through an electric communication line. Further, a part or all of the above functions can be implemented on, for example, a programmable device (PD) as field programmable gate array (FPGA) or implemented as application specific integrated circuit (ASIC). To realize the functions on the PD, circuit configuration data as bit stream data and data written in HDL (hardware description language), VHDL (very high speed integrated circuits hardware description language), and Verilog-HDL stored in a storage medium can be distributed.

Although the present invention has been described in terms of exemplary embodiments, it is not limited thereto. It should be appreciated that variations or modifications may be made in the embodiments described by persons skilled in the art without departing from the scope of the present invention as defined by the following claims.

What is claimed is:

1. An image adjuster which provides an adjustment condition to an image, comprising:
an area evaluator to calculate an area evaluation value for each color in each of divided areas of each of images captured by a plurality of imaging units;
a brightness adjuster to calculate a brightness adjustment value for overlapping divided areas between photographic areas of the images on the basis of the area evaluation value for each color; and
an adjustment value calculator to calculate a balance adjustment value for each of the overlapping divided areas from the area evaluation value for each color on the basis of the brightness adjustment value.

2. The image adjuster according to claim 1, further comprising:
an adjustment value determiner to determine a smoothed balance adjustment value for each of the divided areas by applying weighted averaging to the balance adjustment value in a periphery of each divided area.

3. The image adjuster according to claim 1, wherein
the brightness adjuster comprises
a first calculator to calculate an area brightness value for each of the overlapping divided areas on the basis of the area evaluation value for each color, and
a second calculator to calculate a gain value for each of the captured images as the brightness adjustment value according to a difference in largest area brightness values of the overlapping divided areas of the captured images.

4. The image adjuster according to claim 1, wherein
the adjustment value calculator adjusts the area evaluation value for each color according to the brightness adjustment value to obtain the balance adjustment value.

5. The image adjuster according to claim 1, wherein
the brightness adjuster comprises a third calculator to calculate a corrected offset value for each of the captured images as the brightness adjustment value according to a difference in smallest area brightness values between the overlapping divided areas of the captured images.

6. The image adjuster according to claim 2, wherein
the adjustment value determiner comprises a determiner to determine a weight of the weighted averaging for the overlapping divided areas and non-overlapping divided areas according to a difference in the balance adjustment values between the overlapping divided areas and non-overlapping divided areas.

7. The image adjuster according to claim 1, wherein:
the captured images are captured by different imaging units;
the balance adjustment value is a white balance adjustment value for each of the imaging units and for each of the divided areas of the images from the imaging units.

8. The image adjuster according to claim 1, further comprising
a gain setter provided preceding the area evaluator, to apply an adjustment gain to each of the captured images, the adjustment gain for absorbing a difference between sensitivities of individual solid-state image sensors of the imaging units.

9. An image adjusting method for providing an adjustment condition to an image, causing a computer to execute the steps of:
calculating an area evaluation value for each color in each of divided areas of each of images captured by a plurality of imaging units;
calculating a brightness adjustment value for overlapping divided areas between photographic areas of the images on the basis of the area evaluation value for each color; and
calculating a balance adjustment value for each of the overlapping divided areas from the area evaluation value for each color on the basis of the brightness adjustment value.

10. A non-transitory computer-readable storage medium storing a program for causing a computer to execute the steps of:
calculating an area evaluation value for each color in each of divided areas of each of images captured by a plurality of imaging units;
calculating a brightness adjustment value for overlapping divided areas between photographic areas of the images on the basis of the area evaluation value for each color; and
calculating a balance adjustment value for each of the overlapping divided areas from the area evaluation value for each color on the basis of the brightness adjustment value.
